(19) United States
(12) Patent Application Publication
(10) Pub. No.: US 2014/0321410 A1
(43) Pub. Date: Oct. 30, 2014

(54) Configuring a Communication Channel within a Cell of a Cellular Network Comprising Another Cell which Uses Muting Patterns

(71) Applicants: Frank Frederiksen, Klarup (DK); Klaus Ingemann Pedersen, Aalborg (DK)

(72) Inventors: Frank Frederiksen, Klarup (DK); Klaus Ingemann Pedersen, Aalborg (DK)

(73) Assignee: Nokia Solutions and Networks Oy, Espoo (FI)

(21) Appl. No.: 14/357,079

(22) PCT Filed: Nov. 10, 2011
(86) PCT No.: PCT/EP2011/069791

§ 371 Date: May 8, 2014

(51) Int. Cl. H04L 1/00; H04W 72/04

(52) U.S. Cl. CPC H04L 1/0011; H04W 72/0406; H04W 72/1226
USPC 370/329

(57) ABSTRACT

A method for configuring a first communication channel within a first cell of a cellular network. The method includes determining a first plurality of the subframes of the first communication channel being related in time with the unscheduled subframes of a second communication channel and a second plurality of the subframes of the first communication channel being related in time with the scheduled subframes of the second communication channel, specifying a transmission scheme, by a first base station, for the first communication channel based on the determined first plurality of the subframes and based on the determined second plurality of the subframes, the transmission scheme including a first type of transmission for the first plurality of the subframes and a second type of transmission for the second plurality of the subframes, and configuring, by the first base station, the first communication channel according to the specified transmission scheme.

### FIELD OF INVENTION

The present invention relates to the field of cellular networks and in particular to cellular networks using a muting pattern.

### ART BACKGROUND

In current 3GPP specifications, time domain (TDM) enhanced inter-cell interference coordination (eICIC) has been introduced. The eICIC concept is introducing coordination mechanisms such that it is possible to reduce the interference from an aggressor cell to a victim cell. The TDM eICIC is mainly designed to address downlink interference challenges, but also has some undesirable effects on uplink performance.

Two main use cases were used during the standardization work, the Pico-Macro case and the Macro-Femto case. In the Pico-Macro case, the coverage area of the pico cell (victim cell) is extended by the macro cell (aggressor cell) muting given subframes in the time domain, thereby causing a heavy reduction of the interference seen by the user equipments (UEs) that are connected to the pico node—especially for the UEs that are close to the cell edge of the pico coverage area. In the Macro-Femto case, the aggressor cell is the CSG HeNB (very small base station with closed subscriber group (CSG) for limited access), which will also apply some time domain muting patterns to allow for UEs within the coverage area of the CSG HeNB to be able to “hear” the macro cell. In this way, all macro connected UEs can potentially still be connected to the macro node and avoid experiencing a so-called coverage hole.

Normally, the aggressor cell will apply muting, or at least partial muting, on specific subframes in the time domain so as to reduce the interference detected by users in the victim cell. When applying downlink TDM muting patterns, only essential information (such as information vital to the operation of the system, for instance reference symbols, synchronization sequences, broadcast channels, etc) is conveyed from the aggressor cell. This means that the aggressor cell is not allowed to transmit any information that is related to the downlink direction.

The downlink TDM muting patterns can be indicated to the user equipments (UEs) through dedicated RRC signaling, where the UE is told which subframes in the time domain are to be used for which RRM and CSI measurements. One possibility to introduce muting patterns is the almost blank subframes (ABS), where the aggressor will only transmit limited information (such as information vital to the operation of the system—these include: Reference symbols, synchronization sequences, broadcast channels, etc).

Currently, there exist two slightly different definitions of the ABS concept. In the first case, ABS denotes no transmission of only the necessary channels for basic operation of the system (PSS/SSS/PBCH, common reference symbols (CRS), paging, SI-1). In the second case, ABS can be defined as “Almost blank subframes are subframes with reduced transmit power (including no transmission) on some physical channels and/or reduced activity”.

The issue of applying downlink TDM muting patterns (in the most strict sense) is that only essential information is conveyed from the aggressor cell during ABS. This means that the aggressor cell is not allowed to transmit any scheduling information that is related to the downlink direction. Seen from a downlink scheduling point of view, this is a sensible configuration, as the downlink data channel (physical downlink shared channel—PDCCH) is transmitted within the same transmit time interval (TTI) as the downlink control channel (physical downlink control channel—PDCCH). However, as uplink data also need scheduling through the PDCCH (as all scheduling decisions—also for the uplink direction are taken by the base station), there will be a loss of uplink capacity when applying TDM elCIC. There is a fixed timing relationship between the PDCCH transmitted in the downlink and the uplink transmission on the physical uplink shared channel (PUSCH). With this in mind, it is obvious that introducing a muting pattern with for instance 30% of the subframes muted will cause a 30% loss of the uplink capacity (on the cell using muting, i.e. the aggressor cell). With the second definition of ABS (with lower transmit power on the PDCCH), the scheduling of uplink data for aggressor cells will cause a reduction of the UEs that are available for scheduling to the ones that are having good SINR (signal to interference and noise ratio) conditions (close to the aggressor eNB). As a consequence, the UEs that are close to the cell edge will not be scheduled for UL transmissions in the UL TTIs that are coupled to the ABS muting patterns. This may lead to reduced interferences at the victim node during the ABS of the aggressor node.

There may be a need for an improved system and method, which take into account the muting pattern of the aggressor cell when configuring a communication channel in the victim cell.

### SUMMARY OF THE INVENTION

This need may be met by the subject matter according to the independent claims. Advantageous embodiments of the present invention are described by the dependent claims.

According to a first aspect of the invention there is provided a method for configuring a first communication channel within a first cell of a cellular network, wherein a first base station is assigned to the first cell, and wherein a user equipment is served by the first base station, wherein signals between the first base station and the user equipment are transmittable using the first communication channel, wherein the first communication channel is divided into subframes, wherein the cellular network comprises a second base station being assigned to a second cell, wherein the second base station is adapted to use a second communication channel, wherein the second communication channel is divided into subframes, and wherein a part of the subframes being allocated to uplink transmission is unscheduled by the second base station due to a predefined muting pattern. The method comprises determining, by the first base station, a first plurality of the subframes of the first communication channel being related in time with the unscheduled subframes of the second communication channel and a second plurality of the subframes of the first communication channel being related in time with the scheduled subframes of the second communication channel, specifying a transmission scheme, by the first base station, for the first communication channel based on the determined first plurality of the subframes and based on the determined second plurality of the subframes, the transmission scheme comprising a first type of transmission for the first plurality of the subframes and a second type of transmission for the second plurality of the subframes, and configuring, by the first base station, the first communication channel according to the specified transmission scheme.

This aspect of the invention is based on the idea to consider the muting pattern of the second cell when configuring the communication via the communication channel of the first cell. In the muted, or more specific partial muted (as there may be some essential information (such as information vital to the operation of the system, for instance reference symbols, synchronization sequences, broadcast channels, etc)) or unscheduled subframes, the interferences at the first cell are lower for the user equipment (UE) than in the scheduled subframes. Thus, the method may use this information to potentially boost the UL (uplink) capacity and transmission rates by introducing awareness of muting patterns in the victim node, i.e. the first cell.

The overall concept of TDM eICIC is a well-known concept covering the concept of applying ABS patterns at the aggressor node, informing the victim node of the measurement patterns, transferring measurement restriction patterns to the involved UEs, etc. The described method may introduce a TDM eICIC-aware uplink link adaptation method in the victim eNB that may take the aggressor muting patterns into account when doing scheduling and link adaptation for UEs that will experience less uplink interference from the aggressor cell due to the configured TDM eICIC patterns.

The term “base station” in this context may denote any kind of physical entity being able to hold one or more cells. A base station in this context may be any kind of network device providing the required functionality for the method, it may also be a transceiver node in communication with a centralized entity. According to the first aspect, the first base station and the second base station may be any kind of network devices each being responsible for a communication with their cell, i.e. two different cells that are located at two different locations.

According to an embodiment of the invention, the first communication channel and the second communication channel are at least partially interfering. As described above, the second cell may introduce interferences to the first cell, or more detailed to the communication channel. For instance, in the Pico-Macro case, the coverage area of the pico cell (victim cell, i.e. the first cell) is extended by the macro cell (aggressor cell, second cell) muting given subframes in the time domain, thereby causing a heavy reduction of the interference seen by the user equipments (UEs) that are connected to the pico node—especially for the UEs that are close to the cell edge of the pico coverage area.

Normally, the aggressor cell may apply muting on specific subframes in the time domain so as to reduce the interference detected by users in the victim cell. When applying downlink TDM muting patterns, only essential information (such as information vital to the operation of the system, for instance reference symbols, synchronization sequences, broadcast channels, etc) is conveyed from the aggressor cell. This means that the aggressor cell is not allowed to transmit any information that is related to UE specific behavior in the downlink direction. During the un-muted subframes, or scheduled subframes, of the second cell or second communication channel, the interferences at the first cell or the first communication channel may be high. During the muted subframes, or unscheduled subframes, of the second cell or second communication channel, the interferences at the first cell or the first communication channel may be low, as the second base station is not able to schedule UL traffic due to ABS.

According to a further embodiment of the invention, the method further comprises receiving, by the first base station, the predefined muting pattern from the second base station.

This may be performed for example by using an X2 interface offering the following information element (IE), shown in the table below, to be exchanged from aggressor (second) to victim (first) cell. This IE provides information about which sub frames the sending eNB is configuring as almost blank subframes and which subset of almost blank subframes are recommended for configuring measurements towards the UE. Almost blank subframes are subframes with reduced power on some physical channels and/or reduced activity.

| | | | IE type and | |
|---|---|---|---|---|
| IE/Group Name | Presence | Range | reference | Semantics description |
| CHOICE ABS Information | M | | — | — |
| >FDD | | | — | — |
| >>ABS Pattern | M | | BIT STRING | Each position in the bit- |
| Info | | | (SIZE(40)) | map represents a sub- |
| | | | | frame, for which value “1” |
| | | | | indicates ‘blanked in DL’ |
| | | | | and value “0” indicates |
| | | | | ‘not blanked in DL’. |
| | | | | The first position of the |
| | | | | ABS pattern corresponds |
| | | | | to subframe 0 in a radio |
| | | | | frame where SFN = 0. The |
| | | | | ABS pattern is continuously |
| | | | | repeated in all radio |
| | | | | frames. |
| | | | | The maximum number of |
| | | | | subframes is 40. |
| >>Number Of | M | | ENUMERATED | P (number of antenna |
| Cell-specific Antenna | | | (1, 2, | ports for cell-specific reference |
| Ports | | | 4, . . . ) | signals) defined in |
| | | | | TS 36.211 [10] |
| >>Measurement | M | | BIT STRING | Indicates a subset of the |
| Subset | | | (SIZE(40)) | ABS Pattern Info above, |
| | | | | and is used to configure |
| | | | | specific measurements |
| | | | | towards the UE. |

With this information, the victim node, i.e. the first base station, may know the exact pattern that the aggressor node, i.e. the second base station, will use for reducing power on some channels (and even potentially not even transmit). In these subframes indicated with the “ABS Pattern Info”, the victim node scheduler may use a more aggressive selection of modulation and coding in the link adaptation procedure, as there will be a very high probability that the aggressor connected UEs will not be interfering to the victim node, and the supported throughput might be significantly higher than in the non-muted subframes.

According to a further embodiment of the invention, specifying the transmission scheme comprises scheduling resources of the communication channel for uplink transmission.

The scheduling and link adaptation method may operate with different link adaptation bias values for muted and non-muted subframes (for selection of modulation and coding scheme), such that it might be possible to boost the instantaneous throughput when the interference is expected to be reduced from the aggressor node. The resources of the communication channel for uplink transmission may be scheduled based on the muting pattern.

According to a further embodiment, scheduling resources of the communication channel for uplink transmission comprises assigning a first transmission rate (corresponding to the first type of transmission) to the first plurality of the subframes and a second transmission rate (corresponding to the second type of transmission) to the second plurality of the subframes, wherein the first transmission rate is higher than the second transmission rate.

The transmission rate may be increased during the muted subframes of the second communication channel for boosting the throughput.

According to a further embodiment, specifying the transmission scheme comprises (effectively) selecting a modulation scheme and/or a coding scheme for the first plurality of the subframes and/or the second plurality of the subframes.

In the modulation domain, a higher modulation order may be used than would normally be seen or recommended (due to the prior knowledge that interference level for some subframes will be lower, the SINR will be higher, thereby allowing for selection of higher order modulation). In the channel coding domain, where the preferred solution (from a channel coding point of view) is to use strong channel coding (having many redundancy bits per user information bit), less channel coding may be used, by lowering the number of redundancy bits, and for fixed number of bits available on the radio channel, in order to increase the number of information bits that are transmitted. It may be possible to simultaneously adjust both modulation and coding through control signaling messages in the downlink. In an embodiment, the modulation scheme, physical resource allocation and transport block size may be set, which translates into modulation and coding scheme.

According to a further embodiment of the invention, the modulation scheme and/or coding scheme being selected for the first plurality of the subframes is associated with a signal to noise ratio being higher than a signal to noise ration of the modulation scheme and/or coding scheme being selected for the second plurality of the subframes.

When it is known, due to the muting pattern and the determined first plurality of subframes as well as the second plurality of subframes, that the experienced channel SINR might be higher than what would normally be expected, for example less channel coding may be used and the number of information bits being transmitted may be increased. Therefore, the throughput may be increased.

According to a further embodiment of the invention, configuring the communication channel comprises allocating the subframes of the communication channel to uplink transmission based on the transmission scheme.

The first plurality of the subframes may be allocated to a type of transmission with a higher transmission rate and the second plurality of the subframes may be allocated to a type of transmission with a lower transmission rate.

According to a further embodiment, the method further comprises configuring the user equipment to transmit in accordance with the transmission scheme.

The user equipment may be configured for example to use a higher transmission rate and/or lower coding during the first plurality of the subframes and to use a lower transmission rate and/or higher coding during the second plurality of the subframes.

According to a further embodiment of the invention, configuring the user equipment comprises sending from the base station to the user equipment a signal comprising information about an allocation of resources within the communication channel.

By using such a signal, the UE may know in which resources it should transmit using the first type of transmission and in which resources it should transmit using the second type of transmission. The signal may also comprise information about the coding and/or modulation scheme. The UE may be scheduled dynamically, by using such a signal, so that for each TTI (transmit time interval), it is informed which data rate (modulation and coding scheme) it should use.

According to a second aspect of the invention, there is provided a base station for configuring a first communication channel within a first cell of a cellular network, wherein the base station is assigned to the first cell, and wherein a user equipment is served by the first base station, wherein signals between the first base station and the user equipment are transmittable using the first communication channel, wherein the first communication channel is divided into subframes, wherein the cellular network comprises a second base station being assigned to a second cell, wherein the second base station is adapted to use a second communication channel, wherein the second communication channel is divided into subframes, and wherein a part of the subframes being allocated to uplink transmission is unscheduled by the second base station due to a predefined muting pattern. The base station comprises a determination unit being adapted to determine a first plurality of the subframes of the first communication channel being related in time with the unscheduled subframes of the second communication channel and a second plurality of the subframes of the first communication channel being related in time with the scheduled subframes of the second communication channel, a specification unit being adapted to specify a transmission scheme for the first communication channel based on the determined first plurality of the subframes and based on the determined second plurality of the subframes, the transmission scheme comprising a first type of transmission for the first plurality of the subframes and a second type of transmission for the second plurality of the subframes, and a configuration unit being adapted to configure the first communication channel according to the transmission scheme.

The base station may be any type of access point or point of attachment, which is capable of providing a wireless access to a cellular network system. Thereby, the wireless access may be provided for a user equipment or for any other network element, which is capable of communicating in a wireless manner. The base station may be an eNodeB, eNB, home NodeB or HNB, or any other kind of access point.

The base station may comprise a receiving unit, for example a receiver as known by a skilled person. The base station may also comprise a transmitting unit, for example a transmitter. The receiver and the transmitter may be implemented as one single unit, for example as a transceiver. The transceiver or the receiving unit and the transmitting unit may be adapted to communicate with the second base station or the user equipment via an antenna.

The determination unit, the specification unit and the configuration unit may be implemented as single units or may be implemented as one unit providing the functionalities of all three units. The units may be implemented for example as part of a standard control unit, like a CPU or a microcontroller.

The user equipment (UE) may be any type of communication end device, which is capable of connecting with the described base station. The UE may be in particular a cellular mobile phone, a Personal Digital Assistant (PDA), a notebook computer, a printer and/or any other movable communication device.

The user equipment may comprise a receiving unit or receiver which is adapted for receiving signals from the base station.

The user equipment may comprise a transmitting unit for transmitting signals. The transmitting unit may be a transmitter as known by a skilled person. The receiver and the transmitting unit may be implemented as one single unit, for example as a transceiver. The transceiver or the receiver and the transmitting unit may be adapted to communicate with the base station via an antenna.

The user equipment may comprise a configuration unit for receiving a configuration signal from the base station informing the user equipment about the configuration of the communication channel. Such a configuration unit may be adapted to configure the user equipment to transmit in accordance with the configuration of the communication channel. The configuration unit of the user equipment may be implemented for example as part of a control unit, like a CPU or a microcontroller. The configuration unit and the receiver may be coupled or may be implemented as one single unit.

According to a third aspect of the invention, there is provided a cellular network system, the cellular network system comprising a first cell and a second cell, wherein a base station as described above is assigned to the first cell.

Generally herein, the method and embodiments of the method according to the first aspect may include performing one or more functions described with regard to the second or third aspect or an embodiment thereof. Vice versa, the base station or cellular network system and embodiments thereof according to the second and third aspect may include units or devices for performing one or more functions described with regard to the first aspect or an embodiment thereof.

According to a fourth aspect of the herein disclosed subject-matter, a computer program for configuring a communication channel is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a cellular network system, a base station and a method of configuring a communication channel. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless otherwise notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWING

FIG. 1 shows a cellular network system according to an exemplary embodiment of the present invention.

FIG. 2 shows a timing relation between UL transmissions in the second cell and interferences in the first cell.

FIG. 3 shows a base station and a user equipment within a cellular network system according to an exemplary embodiment of the invention.

### DETAILED DESCRIPTION

The illustration in the drawing is schematically. It is noted that in different figures, similar or identical elements are provided with the same reference signs.

In the following, embodiments of the herein disclosed subject matter are illustrated with reference to the drawings and reference to aspects of current standards, such as LTE.

However, such reference to current standards is only exemplary and should not be considered as limiting the scope of the claims.

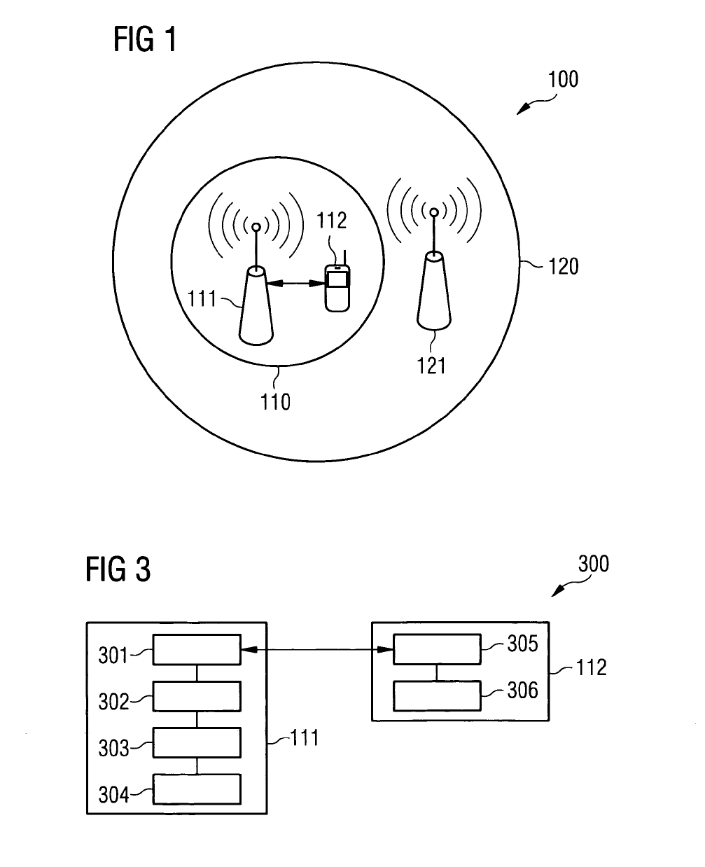

FIG. 1 shows a first cell 110 of a cellular network system 100. A first base station 111 is assigned to the first cell 110 of the cellular network system and a user equipment 112 being served by the first base station. Signals between the first base station and the user equipment are transmittable using a first communication channel, which is divided into subframes.

The cellular network system 100 comprises a second cell 120, wherein a second base station 121 is assigned to the second cell. The second cell may be at least partially overlapping the first cell. In another embodiment, the first cell and the second cell are neighbored, without any overlap, but with some interference between the cells. In one embodiment, the first cell may be smaller than the second cell.

The second base station is adapted to use a second communication channel, wherein the second communication channel is divided into subframes. A part of these subframes being allocated to uplink transmission is unscheduled by the second base station due to a predefined muting pattern.

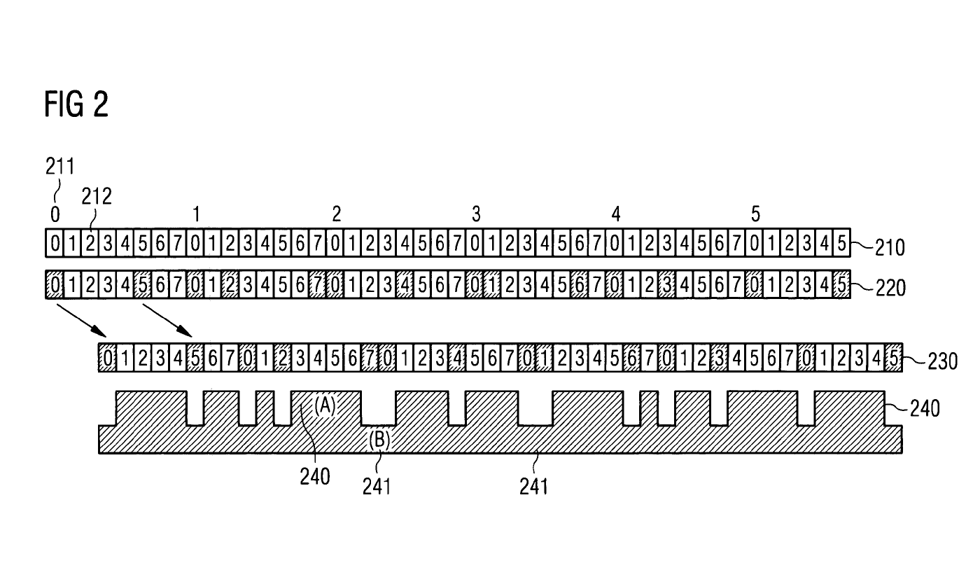

The first base station determines a first plurality of the subframes of the first communication channel being related in time with the unscheduled subframes of the second communication channel and a second plurality of the subframes of the first communication channel being related in time with the scheduled subframes of the second communication channel. This shown in FIG. 2 as explained below.

The first base station specifies a transmission scheme for the first communication channel based on the determined first plurality of the subframes and based on the determined second plurality of the subframes. The transmission scheme comprises a first transmission mode or type of transmission (boost mode) for the first plurality of the subframes and a second transmission mode or type of transmission (standard mode) for the second plurality of the subframes. The first base station then configures the first communication channel, in particular for uplink, according to the specified transmission scheme.

This procedure is based on the idea to introduce a TDM eICIC-aware uplink link adaptation method in the victim eNB (first base station) that will take the aggressor (second base station assigned to second cell) muting patterns into account when doing scheduling and link adaptation for UEs that will experience less uplink interference from the aggressor cell due to the configured TDM eICIC patterns. The scheduling and link adaptation method should be operating with different link adaptation bias values for muted and non-muted subframes (for selection of modulation and coding scheme), such that it is possible to boost the instantaneous throughput when the interference is expected to be reduced from the aggressor node.

The first base station (victim node) might have the possibility to be informed on the ABS pattern(s) applied at the aggressor cell(s). Wth this information, the victim node knows the exact pattern according to which the aggressor node (second base station 121) will be reducing power on some channels (and even potentially not even transmit). In these subframes indicated with the “ABS Pattern Info”, the victim node scheduler, i.e. the first base station 111, might use a more aggressive selection of modulation and coding in the link adaptation procedure, as there will be a very high probability that the aggressor connected UEs will not be interfering to the victim node, and the supported throughput would be significantly higher than in the non-muted subframes.

The term “aggressive selection of modulation and coding by the victim node” may be based in fundamental communication theory. When observing the performance curves for two commonly used modulation schemes such as QPSK and 16-QAM, it is seen that the use of 16-QAM will require a significantly higher signal to noise+interference ratio (SINR) than QPSK. On the other hand, 16-QAM will be able to carry more information bits per transmitted symbol. So in the modulation domain, using a more aggressive modulation scheme may denote that a higher modulation order is used than would normally be seen or recommended (due to the prior knowledge that interference level for some subframes will be lower, the SINR will be higher, thereby allowing for selection of higher order modulation). Correspondingly, a similar mechanism may be applied in the channel coding domain, where the preferred solution (from a channel coding point of view) is to use strong channel coding (having many redundancy bits per user information bit). In the case that it is known that the experienced channel SINR is higher than what would normally be expected, less channel coding can be used (by lowering the number of redundancy bits, and for fixed number of bits available on the radio channel, the number of information bits that are transmitted can be increased). In most modern communication systems, it is possible to simultaneously adjust both modulation and coding through control signaling messages in the downlink.

In LTE uplink, the control message that is sent from the evolved Node B (eNB 111) to the UE 112 consists of a set of instructions that informs the UE of the physical resources that are assigned for uplink transmission. These physical resources are denoted PRBs, and effectively the physical resources are translated to a number of channel symbols that can be used for transmission of user data. At the same time, the eNB informs the UE of the modulation scheme that it is supposed to use. Knowing the modulation scheme, the number of channel bits available for uplink transmission are known (as each modulation scheme can carry a number of bits per symbol (2 for QPSK, 4 for 16-QAM)). Finally, the eNB also informs the UE about the “transport block size”, that is, the number of user information bits that are supposed to be transmitted in the uplink. These user information bits are put through some channel coding (for instance a rate 1/3 turbo encoder), which may increase the number of bits for transmission by approximately a factor of 3. In order to match the coded bits to the available radio channel capacity, a rate matching functionality might either repeat or remove some of the channel coded bits in an organized manner. By setting the amount of physical resources, modulation scheme, and transport block size, the modulation and coding used for the uplink transmission can be effectively adjusted.

As shown in FIG. 2, the use of ABS by an aggressor node will cause the uplink interference to vary according to the ABS pattern. A number 210 of frames 211 is divided into subframes 212. A muting pattern can be applied to the PDCCH 220, wherein the grey fields represent the muted subframes. In this example, the aggressor node (macro node) uses a 30% pattern, where the ABS are shown with grey markings. As there is a scheduling delay of 4 TTIs from the transmission of an UL grant on the PDCCH to the actual uplink transmission, the interference pattern emitted from the aggressor node will have a similar delay (230). When observing the interference levels at the victim node (first base station), there will be two levels of interference:

240: aggressor node is having scheduled UL traffic, and the interference at the victim node will be high, and
241: aggressor node is not able to schedule UL traffic due to ABS, and the interference level at the victim node is low.

When the interference is low, the victim node scheduler and link adaptation should “boost” the throughput to utilize the lower expected interference, as described above. Wth this method, the victim node scheduler can be operated in two modes: “standard” and “boost” modes, where the “boost” mode is used only during the ABS.

FIG. 3 shows a cellular network system 300 according to an exemplary embodiment of the invention. The cellular network system comprises a base station 111 and a user equipment 112 being served by the base station.

The base station 111 is assigned to a first cell of the cellular network system. Signals between the first base station and the user equipment are transmittable using a first communication channel, wherein the first communication channel is divided into subframes.

The cellular network comprises a second cell (not shown), wherein a second base station (not shown) is assigned to the second cell. The second base station is adapted to use a second communication channel, wherein the second communication channel is divided into subframes, and wherein a part of the subframes being allocated to uplink transmission is unscheduled by the second base station due to a predefined muting pattern.

The base station 111 comprises a determination unit 302 being adapted to determine a first plurality of the subframes of the first communication channel being related in time with the unscheduled subframes of the second communication channel and a second plurality of the subframes of the first communication channel being related in time with the scheduled subframes of the second communication channel. The base station comprises further a specification unit 303 being adapted to specify a transmission scheme for the first communication channel based on the determined first plurality of the subframes and based on the determined second plurality of the subframes, the transmission scheme comprising a first type of transmission for the first plurality of the subframes and a second type of transmission for the second plurality of the subframes. Furthermore, the base station comprises a configuration unit 304 being adapted to configure the first communication channel according to the transmission scheme.

The base station 111 may be any type of access point or point of attachment, which is capable of providing a wireless access to a telecommunication network. Thereby, the wireless access may be provided for a user equipment 112 or for any other network element, which is capable of communicating in a wireless manner, for instance also the second base station.

The base station comprises a receiver as known by a skilled person. The base station may also comprise a transmitter. The receiver and the transmitter may be implemented as one single unit, for example as a transceiver 301 as shown in FIG. 3. The transceiver or the receiving unit and the transmitter may be adapted to communicate with the second base station (not shown) or the user equipment 112 via an antenna.

The determination unit, the specification unit and the configuration unit may be implemented for example as part of a standard control unit, like a CPU or a microcontroller, or may be implemented as a single unit.

The user equipment (UE) 112 may be any type of communication end device, which is capable of connecting with the described base station. The UE may be in particular a cellular mobile phone, a Personal Digital Assistant (PDA), a notebook computer, a printer and/or any other movable communication device.

The user equipment may 112 comprise a transmitting unit for transmitting signals to the base station 111. The user equipment further comprises a receiving unit being adapted to receive signals from the first base. The transmitting unit may be a transmitter as known by a skilled person, and the receiving unit may be a common known receiver. The transmitting unit and the receiving unit may be integrated in one single unit, for example a transceiver 305. The transceiver or the receiving and the transmitting unit may be adapted to communicate with the base station via an antenna.

The transceiver 305 may be coupled to a configuration unit 306. The configuration unit 306 of the user equipment may be implemented for example as part of a control unit, like a CPU or a microcontroller, or may be implemented as a single unit providing the described functionality. The configuration unit is adapted to configure the user equipment, based on information provided by the first base station in view of the transmission scheme as used for the first communication channel.

Having regard to the subject matter disclosed herein, it should be mentioned that, although some embodiments refer to a “base station”, “eNB”, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a base station as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the determination unit, are at least in part provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularity on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

### LIST OF REFERENCE SIGNS

100 Cellular network system
110 First cell
111 First base station
112 User equipment
120 Second cell
121 Second base station
210 Frame pattern
211 Frame number
212 Subframe number
220 Muting pattern in PDCCH
230 UL transmission in second cell
240 High interferences at first base station
241 Low interferences at first base station
300 Cellular network system
301 Transceiver of base station
302 Determination unit
303 Specification unit
304 Configuration unit
305 Transceiver of user equipment
306 Configuration unit of user equipment

1. A method for configuring a first communication channel within a first cell of a cellular network, wherein a first base station is assigned to the first cell, and wherein a user equipment is served by the first base station, wherein signals between the first base station and the user equipment are transmittable using the first communication channel, wherein the first communication channel is divided into subframes, wherein the cellular network comprises a second base station being assigned to a second cell, wherein the second base station is adapted to use a second communication channel, wherein the second communication channel is divided into subframes, and wherein a part of the sub-frames being allocated to uplink transmission is unscheduled by the second base station due to a predefined muting pattern, the method comprising
determining, by the first base station, a first plurality of the subframes of the first communication channel being related in time with the unscheduled subframes of the second communication channel and a second plurality of the subframes of the first communication channel being related in time with the scheduled subframes of the second communication channel,
specifying a transmission scheme, by the first base station, for the first communication channel based on the determined first plurality of the subframes and based on the determined second plurality of the subframes, the transmission scheme comprising a first type of transmission for the first plurality of the subframes and a second type of transmission for the second plurality of the subframes, and
configuring, by the first base station, the first communication channel according to the specified transmission scheme.

2. The method as set forth in claim 1, wherein the first communication channel and the second communication channel are at least partially interfering.

3. The method as set forth in claim 1, the method further comprising
receiving, by the first base station, the predefined muting pattern from the second base station.

4. The method as set forth in claim 1, wherein specifying the transmission scheme comprises scheduling resources of the communication channel for uplink transmission.

5. The method as set forth in claim 4, wherein scheduling resources of the communication channel for uplink transmission comprises assigning a first transmission rate to the first plurality of the subframes and a second transmission rate to the second plurality of the subframes, wherein the first transmission rate is higher than the second transmission rate.

6. The method as set forth in claim 1, wherein specifying the transmission scheme comprises selecting a modulation scheme and/or a coding scheme for the first plurality of the subframes and/or the second plurality of the subframes.

7. The method as set forth in claim 6, wherein the modulation scheme and/or coding scheme being selected for the first plurality of the subframes is associated with a signal to noise ratio being higher than a signal to noise ration of the modulation scheme and/or coding scheme being selected for the second plurality of the subframes.

8. The method as set forth in claim 1, wherein configuring the communication channel comprises allocating the subframes of the communication channel to uplink transmission based on the transmission scheme.

9. The method as set forth in claim 1, the method further comprising configuring the user equipment to transmit in accordance with the transmission scheme.

10. The method as set forth in claim 9,
wherein configuring the user equipment comprises
sending from the base station to the user equipment a signal comprising information about an allocation of resources within the communication channel.

11. A base station for configuring a first communication channel within a first cell of a cellular network, wherein the base station is assigned to the first cell, and wherein a user equipment is served by the first base station, wherein signals between the first base station and the user equipment are transmittable using the first communication channel, wherein the first communication channel is divided into subframes, wherein the cellular network comprises a second base station being assigned to a second cell, wherein the second base station is adapted to use a second communication channel, wherein the second communication channel is divided into subframes, and wherein a part of the sub-frames being allocated to uplink transmission is unscheduled by the second base station due to a predefined muting pattern, the base station comprising
a determination unit being adapted to determine a first plurality of the subframes of the first communication channel being related in time with the unscheduled subframes of the second communication channel and a second plurality of the subframes of the first communication channel being related in time with the scheduled subframes of the second communication channel,
a specification unit being adapted to specify a transmission scheme for the first communication channel based on the determined first plurality of the subframes and based on the determined second plurality of the subframes, the transmission scheme comprising a first type of transmission for the first plurality of the subframes and a second type of transmission for the second plurality of the subframes, and
a configuration unit being adapted to configure the first communication channel according to the transmission scheme.

12. A cellular network system, the cellular network system comprising a first cell, wherein a base station as set forth in claim 11 is assigned to the first cell.
